(19) United States
(12) Patent Application Publication
(10) Pub. No.: US 2017/0123881 A1
(43) Pub. Date: May 4, 2017

(54) TEST METHOD OF VOLATILE MEMORY DEVICE EMBEDDED IN ELECTRONIC DEVICE

(71) Applicant: Samsung Electronics Co., Ltd., Suwon-si (KR)

(72) Inventor: Sung-yong SEO, Seongnam-si (KR)

(73) Assignee: Samsung Electronics Co., Ltd., Suwon-si (KR)

(21) Appl. No.: 15/290,381

(22) Filed: Oct. 11, 2016

(30) Foreign Application Priority Data
Oct. 30, 2015 (KR) 10-2015-0152535
Feb. 11, 2016 (KR) 10-2016-0015679

(51) Int. Cl. G06F 11/07; G06F 11/14; G06F 9/44; G06F 3/06; G06F 11/20

(52) U.S. Cl. CPC G06F 11/0727; G06F 3/0619; G06F 3/0632; G06F 3/0685; G06F 11/0751; G06F 11/0793; G06F 11/2094; G06F 9/4401; G06F 11/1417

(57) ABSTRACT

A method of operation of an electronic device comprising a storage device in which a volatile memory device and a non-volatile memory device are embedded include initializing a memory controller connected to the volatile memory device, via a host connected to the storage device; obtaining first and second error-free regions in the volatile memory device by testing the volatile memory device using the memory controller via the host, the second error-free region being different from the first error-free region; generating an address map with respect to a defective cell region of the volatile memory device via the host, based on the testing; and executing program code of an operating system (OS) of the electronic device, the program code of the OS being stored in the non-volatile memory device, the executing including loading the OS to the volatile memory device based on the address map via the host.

### CROSS-REFERENCE TO RELATED APPLICATION

This application claims the benefit of Korean Patent Application No. 10-2015-0152535, filed in the Korean Intellectual Property Office on Oct. 30, 2015, and Korean Patent Application No. 10-2016-0015679, filed in the Korean Intellectual Property Office on Feb. 11, 2016, the disclosures of each of which are incorporated herein in their entirety by reference.

### BACKGROUND

1. Field

At least some example embodiments of the inventive concepts relate to a semiconductor device, and more particularly, to a method of testing a volatile memory device embedded in an electronic device to avoid using a defective cell region of the volatile memory device.

2. Related Art

Computer information technologies are widely used as in portable electronic devices, such as personal digital assistants (PDAs), smartphones, digital cameras, MP3 players, laptop computers, etc. Some portable electronic devices require more compact and high capacity storage devices and thus, have embedded therein more compact and high capacity storage devices. Some electronic devices operate on an assumption that all memory cells of a storage device embedded in the electronic devices are good cells and store data in the memory cells.

Storage devices embedded in the electronic devices may include defective memory cells due to a problem in a design or a process of manufacturing, or due to physical deterioration. When an electronic device is booted up, the electronic device may not operate if a basic input output system (BIOS) of the electronic device or a bootloader code is stored in a memory region including defective memory cells. Thus, to avoid using defective cell regions of the storage device embedded in the electronic device, a test with respect to the storage device may be used.

### SUMMARY

At least some example embodiments of the inventive concepts provide a method of testing a volatile memory device embedded in an electronic device and an operation method of the electronic device.

According to at least some example embodiments, a method of operation of an electronic device comprising a storage device in which a volatile memory device and a non-volatile memory device are embedded includes initializing a memory controller connected to the volatile memory device, via a host connected to the storage device; obtaining a first error-free region and a second error-free region in the volatile memory device by testing the volatile memory device using the memory controller via the host, the second error-free region being different from the first error-free region; generating an address map with respect to a defective cell region of the volatile memory device via the host, based on a result of the testing of the volatile memory device; and executing program code of an operating system (OS) of the electronic device, the program code of the OS being stored in the non-volatile memory device, the executing including loading the OS to the volatile memory device based on the address map via the host.

According to at least some example embodiments, a method of testing a volatile memory device embedded in an electronic device includes performing a first test on a memory region of the volatile memory device; determining whether a first error-free region is obtained in the memory region, based on a result of the first test; performing a second test on a memory region of the volatile memory device when the first error-free region is obtained; determining whether a second error-free region that is different from the first error-free region is obtained in the memory region, based on a result of the second test; and when the second error-free region is obtained, performing a booting operation of the electronic device by using the first and second error-free regions.

According to at least some example embodiments, a method of operating an electronic device includes performing a booting operation including, initializing a memory controller of the electronic device in response to powering-on of the electronic device, performing, by the memory controller, a first test operation including testing volatile memory of the electronic device, performing, by the memory controller, a second test operation including testing the volatile memory of the electronic device, when the first test operation indicates that the volatile memory includes at least a first error-free region, and loading, by the memory controller, program code of an operating system (OS) of the electronic device into the volatile memory, when the second test operation indicates that the volatile memory includes at least a second error-free region different from the first error-free region.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram of an electronic device including a volatile memory device obtaining error-free regions, according to at least some example embodiments of the inventive concepts;

FIG. 2 is a block diagram of the electronic device of FIG. 1 in more detail;

FIG. 3 is a flowchart of a booting method of the electronic device of FIG. 2;

FIG. 4 is a flowchart of a method of testing a volatile memory device of a memory unit of FIG. 2;

FIG. 5 is a flowchart of a method of detecting error-free regions in the volatile memory device of FIG. 4;

FIG. 6 is a diagram of error-free regions obtained by the method of detecting error-free regions of FIG. 5;

FIG. 7 is a block diagram of an embedded multimedia card (eMMC) system that includes a volatile memory device obtaining error-free regions, according to at least some example embodiments of the inventive concepts; and

FIG. 8 is a block diagram of a universal flash storage (UFS) system that includes a volatile memory device obtaining error-free regions, according to at least some example embodiments of the inventive concepts.

### DETAILED DESCRIPTION OF THE EMBODIMENTS

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

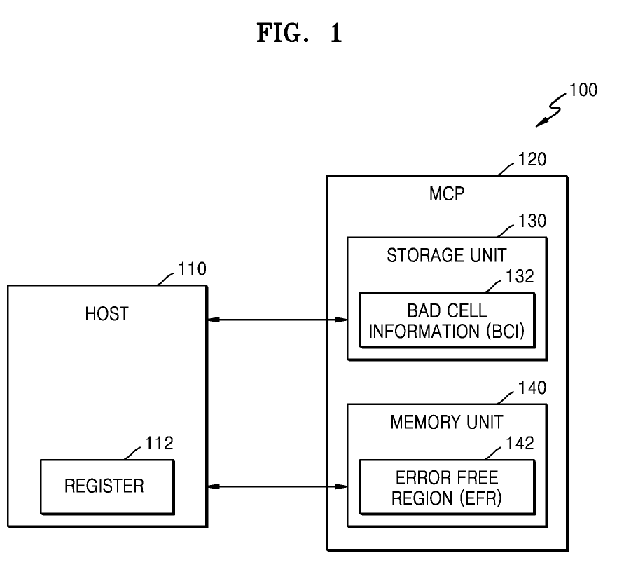

FIG. 1 is a block diagram of an electronic device 100 including a volatile memory device obtaining error-free regions, according to at least some example embodiments of the inventive concepts.

Referring to FIG. 1, the electronic device 100 includes a host 110 and a storage device 120. Example devices that the electronic device 100 may be realized as include, but are not limited to, a personal computer (PC), a laptop computer, a mobile phone, a smartphone, a tablet PC, a personal digital assistant (PDA), an enterprise digital assistant (EDA), a digital camera, a portable multimedia player (PMP), a portable navigation device (PND), MP3 players, e-books, or the like.

The host 110 and the storage device 120 may be connected to each other via, for example, standard interfaces, examples of which include, but are not limited to, flash storage, universal flash storage (UFS), serial advanced technology attachment (SATA), small computer small interface (SCSI), serial attached SCSI (SAS), embedded multimedia card (eMMC), etc.

The host 110 controls general operations of the electronic device 100. The host 110 may include applications that include various application programs executed in the electronic device 100, and peripheral devices connected to the host 110 for use, for example, a device driver for driving the storage device 120. The applications and the device driver may be realized as software or firmware.

The host 110 may store an address map with respect to defective cells of a memory unit 140, in the memory unit 140 of the storage device 120, and may store an address of the address map in a register 112. The address map may be generated based on bad cell information according to test results of the memory unit 140 when the electronic device 100 is booted, and bad cell information 132 of the memory unit 140, which is stored in a storage unit 130.

The storage device 120 may include one or more memory devices, examples of which include, but are not limited to, a solid state drive (SSD), a flash memory card, a multimedia card (MMC), a universal serial bus (USB) flash drive, smartmedia, compact flash, a memory stick, a secure digital (SD) card, UFS, or the like.

The storage device 120 may include the storage unit 130 formed as a non-volatile memory device and the memory unit 140 formed as a volatile memory device. According to at least some example embodiments of the inventive concepts, the storage device 120 may be provided as a multi-chip package (MCP) in which the storage unit 130 and the memory unit 140 are realized as one package. According to at least some example embodiments of the inventive concepts, each of the storage unit 130 and the memory unit 140 of the storage device 120 may be provided as a separate chip.

The storage unit 130 may perform a write or read operation in response to a request of the host 110. The storage unit 130 may store the bad cell information 132 of the memory unit 140. The bad cell information 132 of the memory unit 140, which is stored in the storage unit 130, may be an address of defective cells or bad cells detected at a test during manufacturing of the memory unit 140.

The storage unit 130 may include a non-volatile memory device, examples of which include, but are not limited to, a NAND flash memory, a vertical NAND (VNAND, 3D) flash memory, a NOR flash memory, phase-change random access memory (PRAM), resistive random access memory (RRAM), magnetroresistive random access memory (MRAM), ferroelectric random access memory (FRAM), spin transfer torque random access memory (STT-RAM), or the like.

The memory unit 140 may be formed as a volatile memory device that performs a write or read operation in response to a request of the host 110. A test operation for obtaining an error-free region 142 in a memory region of the volatile memory device when the electronic device 100 is booted may be performed with respect to the memory unit 140.

The memory unit 140 may include random access memory (RAM), examples of which include, but are not limited to, dynamic random access memory (DRAM), such as synchronous DRAM (SDRAM), double data rate (DDR) SDRAM, low power double data rate (LPDDR) SDRAM, graphics double data rate (GDDR) SDRAM, DDR2 SDRAM, DDR3 SDRAM, DDR4 SDRAM, etc., or static random access memory (SRAM).

A boot program of a basic input output system (BIOS) of the electronic device 100, data according to driving of the boot program, a storage device driver for driving the storage unit 130, and the bad cell information 132 of the memory unit 140 may be stored in the error-free region 142 of the memory unit 140.

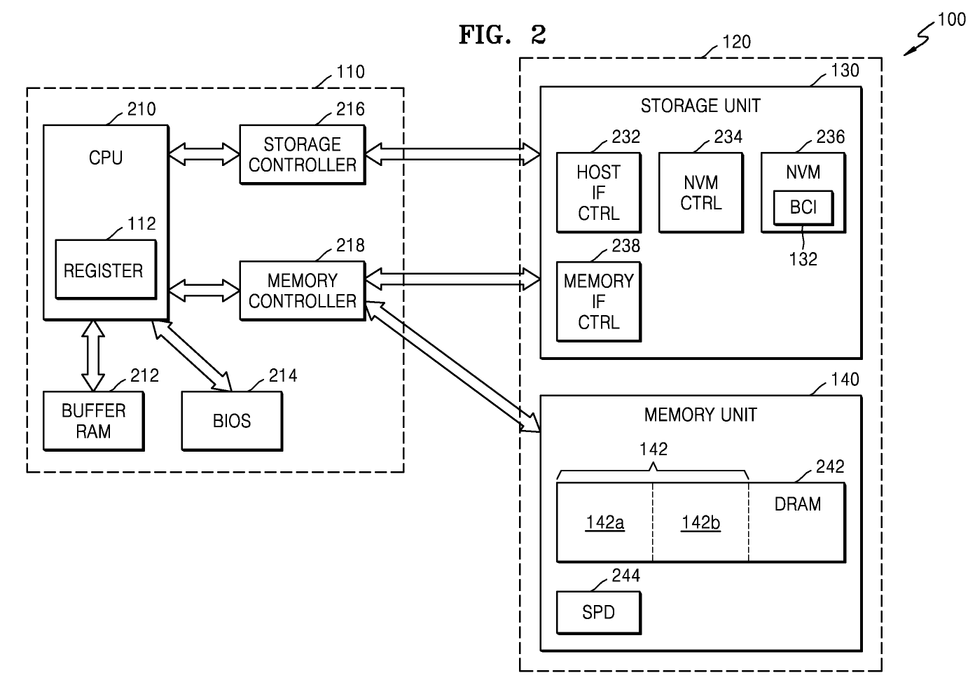

FIG. 2 is a block diagram of the electronic device 100 of FIG. 1 in detail.

Referring to FIG. 2, the host 110 may include a central processing unit (CPU) 210, a buffer RAM 212, a BIOS storage unit 214, a storage controller 216, and a memory controller 218.

The CPU 210 may control general operations of the electronic device 100. The buffer RAM 212 may be used as main memory or cache memory of the host 110, and/or may be used as memory for temporally storing data that is to be provided to the storage device 120. Further, the buffer RAM 212 may be used as driving memory for driving software, such as an application, a device driver, etc.

The BIOS storage unit 214 may be realized as a non-volatile memory device, such as read only memory (ROM), for storing a BIOS program of the electronic device 100. The storage controller 216 may control general operations of the storage unit 130, such as writing, reading, erasing, etc.

The memory controller 218 may control general operations of the memory unit 140, such as writing, reading, erasing, etc. The memory controller 218 may control a test operation for obtaining the error-free region 142 of the memory unit 140 when the electronic device 100 is booted.

The storage unit 130 of the storage device 120 may include a host interface controller 232, a non-volatile memory controller 234, a non-volatile memory device 236, and a memory interface controller 238.

The host interface controller 232 may control data communication between the storage controller 216 and the storage unit 130. The non-volatile memory controller 234 may control, for example, a writing, reading, or erasing operation of the non-volatile memory device 236 in response to a command of the host 110 that is received via the host interface controller 232.

The non-volatile memory device 236 may include one or more types of non-volatile memory, examples of which include, but are not limited to, a flash memory, MRAM, PRAM, RRAM, FRAM, STT-MRAM, or the like. The non-volatile memory device 236 may store the bad cell information 132 of the volatile memory device 242. The bad cell information 132 may include one or more addresses of defective cells or bad cells generated as a result of a test performed during manufacturing of the volatile memory device 242.

The memory interface controller 238 may control data communication between the memory controller 218 and the storage unit 130. The bad cell information 132 of the volatile memory device 242 that is stored in the storage unit 130 may be provided to the memory controller 218 via the memory interface controller 238, and the memory controller 218 may provide the bad cell information 132 to the CPU 210 and the volatile memory device 242. The memory controller 218 may store the bad cell information 132 in the volatile memory device 242 by connecting the bad cell information 132 with an address of an address map stored in the register 112 of the CPU 210.

According to at least some example embodiments of the inventive concepts, when the memory unit 140 is realized as a memory module, the bad cell information 132 of the volatile memory device 242 may be provided from serial presence detect (SPD) storage 244 mounted in the memory module. For example, the memory module may store the SPD data in a portion of the memory module (e.g., SPD storage). For example, the memory module may include, as SPD storage, an electrically erasable and programmable read only memory (EEPROM) in which the SPD data is stored.

The volatile memory device 242 of the memory unit 140 may include RAM, examples of which include, but are not limited to, DRAM, SRAM, etc. A test operation for obtaining a first error-free region 142a and a second error-free region 142b in memory regions when the electronic device 100 is booted may be performed with respect to the volatile memory device 242. A boot program of the BIOS of the electronic device 100 and data according to driving of the boot program may be stored in the first error-free region 142a. A storage device driver for driving the storage unit 130 and the bad cell information 132 of the memory unit 140 may be stored in the second error-free region 142b.

The electronic device 100 according to at least some example embodiments of the inventive concepts may test the volatile memory device 242 embedded in the storage device 120 and obtain the first and second error-free regions 142a and 142b, in which software used for booting of the electronic device 100 is stored. Accordingly, a stable operation of the electronic device 100 may be secured when the electronic device 100 is booted.

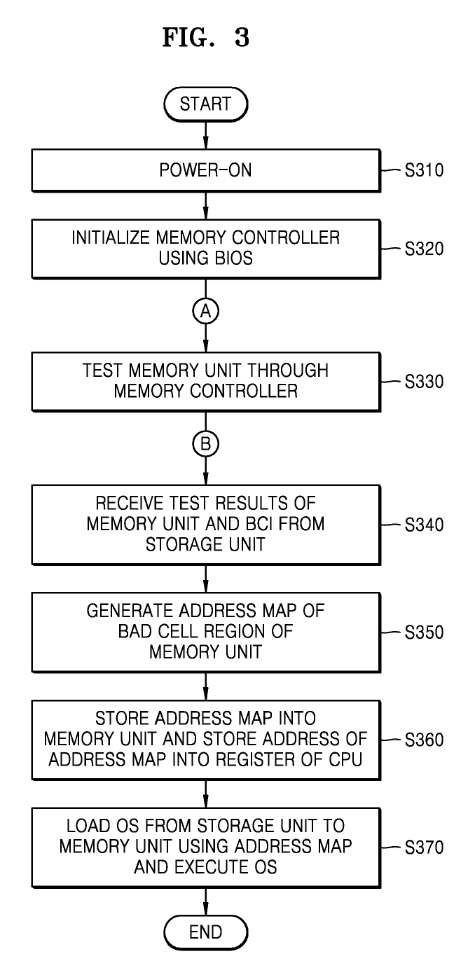

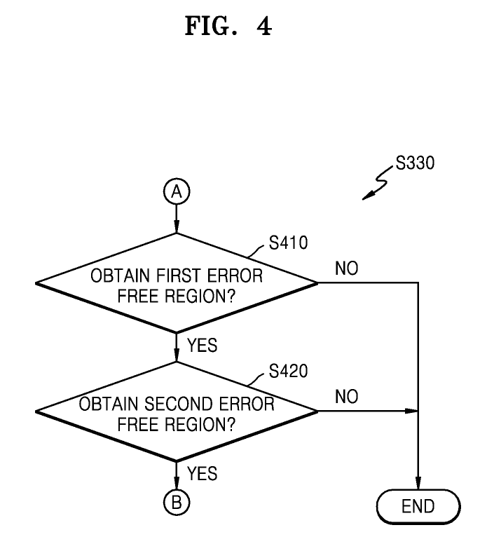

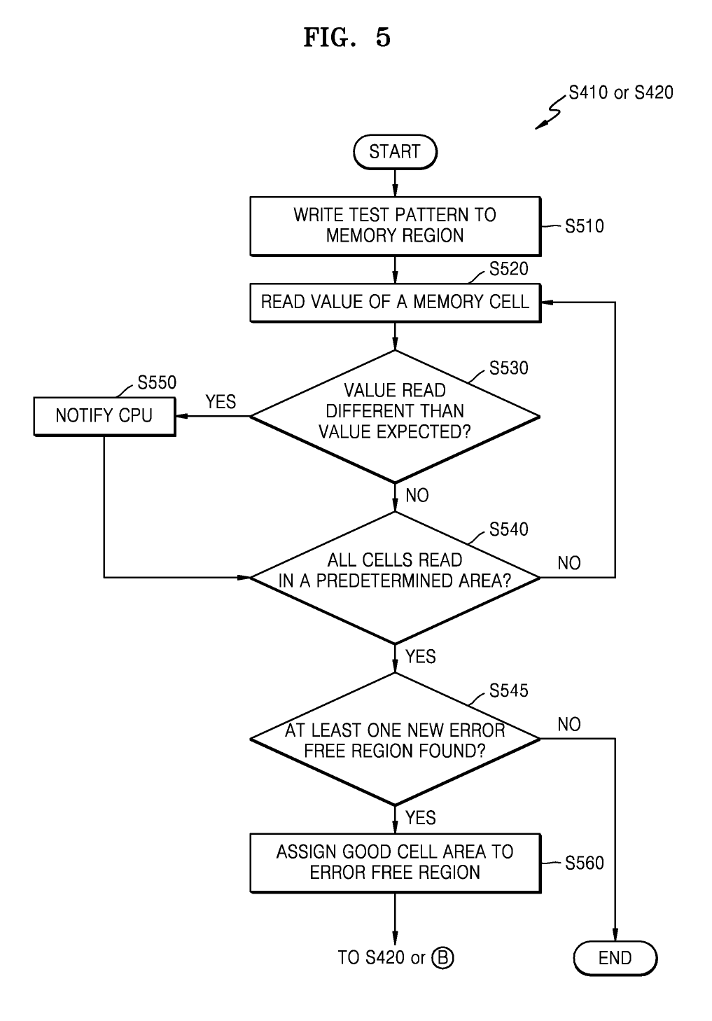

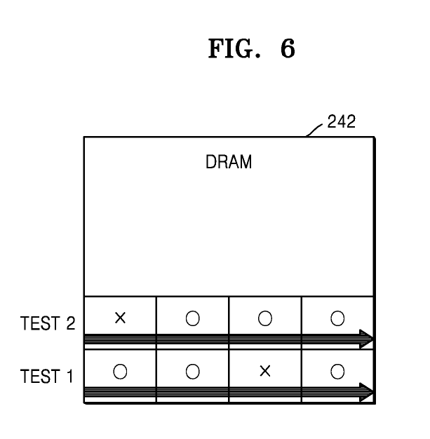

FIGS. 3 through 6 are views for describing an operation of the electronic device 100 according to at least some example embodiments of the inventive concepts. FIG. 3 is a flowchart of a method of booting the electronic device 100, FIG. 4 is a flowchart of a method of testing the volatile memory device 242 of the memory unit 140, FIG. 5 is a flowchart of a method of detecting error-free regions in the volatile memory device 242, and FIG. 6 is a diagram of the first and second error-free regions 142a and 142b obtained by the method of detecting error-free regions of FIG. 5.

Referring to FIG. 3 together with FIG. 2, when the electronic device 100 is booted, the volatile memory device 242 of the memory unit 140 is tested so that the error-free regions 142a and 142b may be obtained in the memory region.

In operation S310, the electronic device 100 may start booting due to power-on by a user. Alternatively, the electronic device 100 may be in a situation in which the electronic device 100 is automatically rebooted due to a system error generated during a previous operation. When the electronic device 100 is supplied with power, the CPU 210 may execute a BIOS of the BIOS storage unit 214.

In operation S320, the memory controller 218 may be initialized by using the BIOS. The BIOS may include initialization settings of the memory controller 218. When the memory controller 218 is initialized, the CPU 210 may access the memory unit 140.

In operation S330, the CPU 210 may test the volatile memory device 242 of the memory unit 140 via the memory controller 218. The test with respect to the volatile memory device 242 may include operations S410 and S420 for obtaining the first and second error-free regions 142a and 142b, as illustrated in FIG. 4.

Referring to FIG. 4, in operation S410, when a first test is performed (e.g., by the CPU 210 and/or memory controller 218) on the volatile memory device 242 and it is determined (e.g., by the CPU 210 and/or memory controller 218) that the first error-free region 142a is obtained in the memory unit 140, the process proceeds to operation S420. On the contrary, when it is determined (e.g., by the CPU 210 and/or memory controller 218) that the first error-free region 142a is not obtained, the process ends the booting operation of the electronic device 100.

In operation S420, when a second test is performed (e.g., by the CPU 210 and/or memory controller 218) on the volatile memory device 242 and it is determined (e.g., by the CPU 210 and/or memory controller 218) that the second error-free region 142b is obtained in the memory unit 140, the process proceeds to operation S340 of FIG. 3. On the contrary, when it is determined (e.g., by the CPU 210 and/or memory controller 218) that the second error-free region 142b is not obtained, the process ends the booting operation of the electronic device 100.

Each of operations S410 and S420 for obtaining the first and second error-free regions 142a and 142b may be performed by implementing the memory test method of FIG. 5.

Referring to FIG. 5, in operation S510, a test pattern, for example, a checker-board pattern 10101010101 may be written (e.g., by the memory controller 218) to some or all of memory regions of the volatile memory device 242. The test pattern may be provided in various forms via the CPU 210. According to at least some example embodiments of the inventive concepts, the test pattern may be provided by an external medium of the electronic device 100.

In operation S520, memory cell data of the memory regions may be read (e.g., by the memory controller 218).

In operation S530, the memory cell data that is read may be compared (e.g., by the memory controller 218) with expected data corresponding to the written test pattern. When it is determined (e.g., by the memory controller 218) according to a result of the comparison that the memory cell data and the expected data do not differ from each other, the process proceeds to operation S540.

In operation S540, whether all memory cells in regions that may be assigned as the first error-free region 142a are read or not may be determined (e.g., by the memory controller 218). When it is determined (e.g., by the memory controller 218) that not all memory cells are read, the process may proceed to operation S520 and reading of remaining memory cells may be performed. According to at least some example embodiments of the inventive concepts, the reading of remaining memory cells may be performed (e.g., by the memory controller 218) by increasing a memory address that is read by 1.

Back to operation S530, when the memory cell data that is read in operation S520 differs from the expected data, the process proceeds to operation S550.

In operation S550, the volatile memory device 242 of the memory unit 140 and/or the memory controller 218 may inform the CPU 210 of the memory cell defect. The CPU 210 may receive address information with respect to the memory cell defect as a result of the memory test. Thereafter, the CPU 210 and/or the memory controller 218 may determine (S540) whether all memory cells in regions that may be assigned as the first error-free region 142a are read or not, and when the CPU 210 and/or the memory controller 218 determine that not all memory cells are read, the process may proceed to operation S520, and reading of remaining memory cells may be performed (e.g., by the memory controller 218).

When it is determined (e.g., by the CPU 210 and/or the memory controller 218) that all memory cells in regions that may be assigned as the first error-free region 142a are read, in operation S540, the process proceeds to operation S560.

In operation S560, the CPU 210 may assign a good memory cell region in which there are no defective memory cells, from among the tested regions, as the first error-free region 142a. Thus, the volatile memory device 242 of the memory unit 140 may obtain the first error-free region 142a. The first error-free region 142a may store a boot program of a BIOS and data according to driving of the boot program.

Operation S410 for obtaining the first error-free region 142a, described above, may be likewise applied to operation S420 for obtaining the second error-free region 142b. According to at least some example embodiments of the inventive concepts, the second error-free region 142b may be configured to be larger than the first error-free region 142a. The second error-free region 142b may store the storage device driver stored in the non-volatile memory device 236 and bad cell information (BCI) of the volatile memory device 242 of the memory unit 140. According to at least some example embodiments of the inventive concepts, the second error-free region 142b may be configured as the same size as the first error-free region 142a.

In FIG. 4, operation S410 for obtaining the first error-free region 142a may be referred to as a first test TEST1, and operation S420 for obtaining the second error-free region 142b may be referred to as a second test TEST2. By the test method S330 of the volatile memory device 242 of FIG. 4, test results illustrated in FIG. 6 may be obtained. According to at least some example embodiments, in operation S330, the memory controller 218 may store the results of the tests performed in operations S410 and S420 in the memory unit 140 (e.g., in volatile memory device 242).

Referring back to FIG. 3, when test results of tests of operations S410 and/or S420 with respect to the volatile memory device 242 of the memory unit 140 are obtained in operation S330, the process proceeds to operation S340.

In operation S340, the CPU 210 may receive the test results of the tests performed in operation S330 with respect to the volatile memory device 242 from the memory unit 140 (e.g., via the memory controller 218). That is, the CPU 210 may receive bad cell information based on the test results of the tests performed in operation S330 with respect to the volatile memory device 242. Also, the CPU 210 may receive the bad cell information 132 of the volatile memory device 242, which is stored in the non-volatile memory device 236 of the storage unit 130. The bad cell information 132 stored in the non-volatile memory device 236 may be provided to the CPU 210 via the host interface controller 232, for example, under the control of the storage controller 216. According to at least some example embodiments of the inventive concepts, the bad cell information 132 of the volatile memory device 242 may be stored in the SPD storage 244 of the memory unit 140 and the bad cell information stored in the SPD storage 244 may be provided to the CPU 210.

In operation S350, the CPU 210 may generate one or more addresses of an address map identifying one or more defective cell regions among memory regions of the volatile memory device 242 of the memory unit 140, based on the bad cell information indicated by the test results of the tests performed in operation S330 and the bad cell information 132 stored in the non-volatile memory device 236.

In operation S360, the CPU 210 may store the address map generated in operation S350 in the volatile memory device 242 of the memory unit 140, and may store the address of the address map in the register 112 in the CPU 210. According to at least some example embodiments of the inventive concepts, the volatile memory device 242 of the memory unit 140 may receive and store the bad cell information 132 stored in the non-volatile memory device 236, via the memory interface controller 238 of the storage unit 130 and the memory controller 218.

In operation S370, according to at least some example embodiments, the CPU 210, storage controller 216 and/or the memory controller 218 may cause program instructions (e.g., software) of an operating system (OS) stored in the storage unit 130 to be loaded into the memory unit 140 based on the address map generated in operation S350.

As described above, since the volatile memory device 242 embedded in the electronic device 100 is tested and the first and second error-free regions 142a and 142b for storing software used for booting of the electronic device 100 are obtained, a stable operation of the electronic device 100 may be secured when the electronic device 100 is booted.

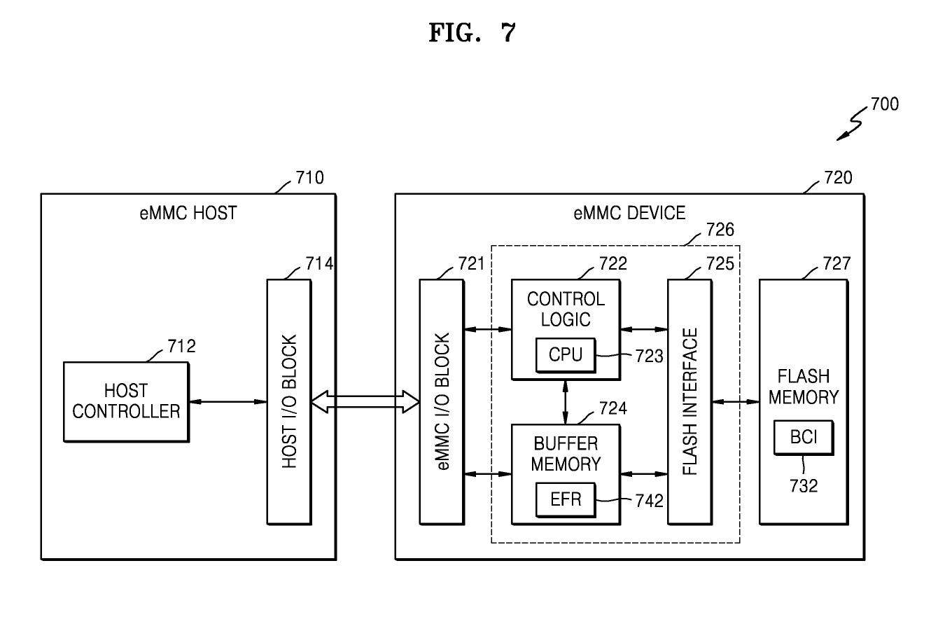

FIG. 7 is a block diagram of an embedded multimedia card (eMMC) system including a volatile memory device obtaining error-free regions, according to at least some example embodiments of the inventive concepts.

Referring to FIG. 7, the eMMC system 700 includes an eMMC host 710 and an eMMC device 720. The eMMC host 710 and the eMMC device 720 may be connected to each other via an eMMC interface.

The eMMC host 710 may refer to a microprocessor or an application processor, which may be embedded or realized in an electronic device. The electronic device may include PCs, laptop computers, mobile phones, smartphones, tablet PCs, PDAs, EDAs, digital cameras, PMPs, PNDs, MP3 players, e-books, or the like.

The eMMC host 710 may control a data process operation of the eMMC device 720, such as a data read operation, a data write operation, etc. The eMMC host 710 may include a host controller 712 and a host input output block 714. During a data read operation, the host controller 712 may receive data that is read from a flash memory 727 of the eMMC device 720 via the host input/output block 714. During a data write operation, the host controller 712 may transmit data that is to be written to the flash memory 727 of the eMMC device 720, to the host input output block 714.

The eMMC host 710 may generate a clock signal that is to be used in the eMMC host 710 and the eMMC device 720 and provide the generated clock signal to the eMMC device 720. Also, the eMMC host 710 may generate input/output operation voltages that are to be used in the host controller 712 and provide the generated input/output operation voltages to the host controller 712. Also, the eMMC host 710 may generate core operation voltages that are to be used in the flash memory 727 of the eMMC device 720 and provide the generated core operation voltages to the eMMC device 720.

The eMMC device 720 may be realized as a multi-chip package including an eMMC input output block 721, a control logic block 722, a buffer memory 724, a flash interface 725, and a flash memory 727. The control logic block 722 including a CPU 723, the buffer memory 724, and the flash interface 725 may operate as an eMMC controller 726 that controls data communication between the eMMC host 710 and the flash memory 727. The flash memory 727 may store bad cell information 732 of the buffer memory 724.

During the data write operation, data received via the eMMC input output block 721 may be temporarily stored in the buffer memory 724, according to control of the CPU 723. The flash interface 725 may read the data that is stored in the buffer memory 724 according to control of the CPU 723 and write the read data to the flash memory 727.

During the data read operation, the flash interface 725 may store data that is output from the flash memory 727 in the buffer memory 724 according to control of the CPU 723. The data stored in the buffer memory 724 according to control of the CPU 723 may be transmitted to the host input output block 714 via the eMMC input output block 721.

The eMMC system 700 may obtain an error-free region 742 for obtaining software used for booting of the eMMC system 700, by testing the buffer memory 724, for example, using the methods described above with respect to FIGS. 1-6. Thus, a stable operation of the eMMC system 700 may be secured when the eMMC system 700 is booted.

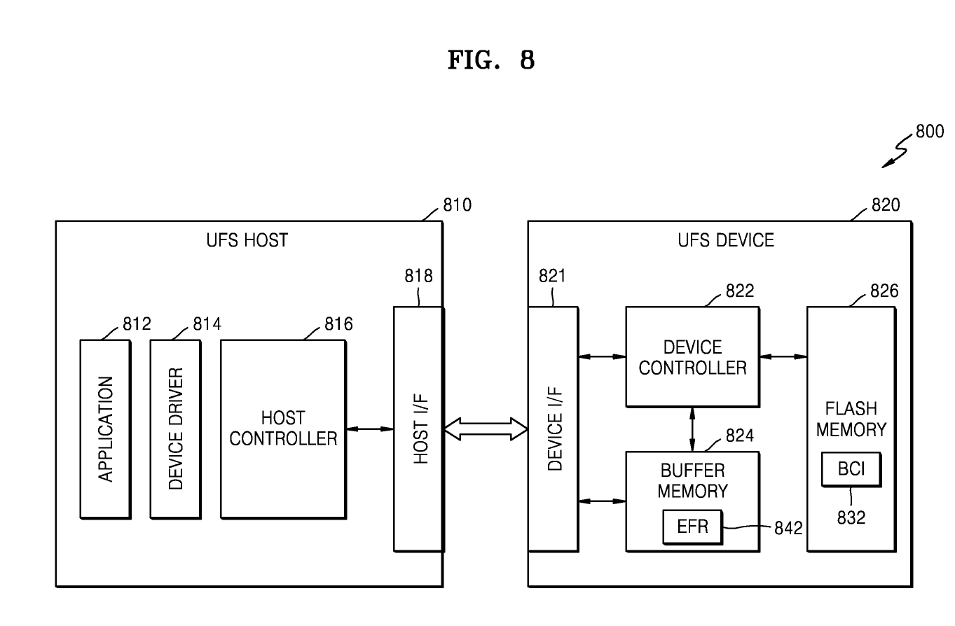

FIG. 8 is a block diagram of a UFS system 800 including a volatile memory device obtaining error-free regions, according to at least some example embodiments of the inventive concepts.

Referring to FIG. 8, the UFS system 800 includes a UFS host 810 and a UFS device 820. The UFS host 810 and the UFS device 820 may be connected to each other via a UFS interface. The UFS system 800 may be based on a flash memory and may be used, for example, in mobile devices, such as smartphones.

The UFS host 810 may include an application 812, a device driver 814, a host controller 816, and a host interface 818. The application 812 includes various application programs executed in the UFS host 810. The device driver 814 is configured to drive peripheral devices connected to the UFS host 810 for use, and may drive the UFS device 820. The application 812 and the device driver 814 may be realized as software, firmware, or the like.

The host controller 816 may generate a protocol or a command to be provided to the UFS device 820 in response to a request of the application 812 and the device driver 814, and may provide the generated command to the UFS device 820 via the host interface 818. When a write request is received from the device driver 814, the host controller 816 may provide a write command and data to the UFS device 820 via the host interface 818, and when a read request is received, the host controller 816 may provide a read command to the UFS device 820 and receive data from the UFS device 820 via the host interface 818.

The UFS device 820 may be connected to the UFS host 810 via a device interface 821. The host interface 818 and the device interface 821 may be connected to each other via a data line for exchanging data or signals and via a power line for supplying power.

The UFS device 820 may include a device controller 822, a buffer memory 824, and a flash memory 826. The device controller 822 may control general operations of the flash memory 826, such as writing, reading, erasing, etc. The device controller 822 may exchange data with the buffer memory 824 or the flash memory 826 via an address and a data bus. The flash memory 826 may store bad cell information 832 of the buffer memory 824. The device controller 822 may include a CPU, direct memory access (DMA), flash DMA, a command manager, a buffer manager, a flash transformation layer (FTL), a flash manager, or the like.

The UFS device 820 may provide a command received from the UFS host 810 to device DMA and the command manager via the device interface 821. The command manager may assign the buffer memory 824 for receiving data via the buffer manager, and when data transmission is ready, may transmit a response signal to the UFS host 810.

The UFS host 810 may transmit data to the UFS device 820 in response to the response signal. The UFS device 820 may store the transmitted data in the buffer memory 824 via the device DMA and the buffer manager. The data stored in the buffer memory 824 may be provided to the flash manager via flash DMA, and the flash manager may store the data in a selected address of the flash memory 826 with reference to address mapping information of the FTL.

When data transmission and a program necessary for a command of the UFS host 810 are completed, the UFS device 820 may transmit a response signal to the UFS host 810 via the device interface 821 and inform the UFS host 810 of a command completion. The UFS host 810 may inform the device driver 814 and the application 812 of whether the command with respect to which the response signal is transmitted is completed or not, and may end the command.

The UFS system 800 may obtain the error-free region 842 for storing software used for booting of the UFS system 800, by testing the buffer memory 824, for example, using the methods described above with respect to FIGS. 1-6. Thus, a stable operation of the UFS system 800 may be secured when the UFS system 800 is booted.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

1. A method of operation of an electronic device comprising a storage device in which a volatile memory device and a non-volatile memory device are embedded, the method comprising:
initializing a memory controller connected to the volatile memory device, via a host connected to the storage device;
obtaining a first error-free region and a second error-free region in the volatile memory device by testing the volatile memory device using the memory controller via the host, the second error-free region being different from the first error-free region;
generating an address map with respect to a defective cell region of the volatile memory device via the host, based on a result of the testing of the volatile memory device; and
executing program code of an operating system (OS) of the electronic device, the program code of the OS being stored in the non-volatile memory device, the executing including loading the OS to the volatile memory device based on the address map via the host.

2. The method of claim 1, further comprising:
storing a boot program of the electronic device and data according to driving of the boot program in the first error-free region.

3. The method of claim 1, further comprising:
storing a device driver for driving the non-volatile memory device in the second error-free region.

4. The method of claim 1, further comprising:
storing, in the second error-free region, information about bad cells of the volatile memory device that is stored in the non-volatile memory device.

5. The method of claim 1, further comprising:
storing, in the second error-free region, information about bad cells of the volatile memory device that is provided from serial presence detect (SPD) storage of a memory module in which the volatile memory device is mounted.

6. The method of claim 1, further comprising:
generating the address map based on information about bad cells of the volatile memory device and results of the testing of the volatile memory device, the information about bad cells of the volatile memory device being stored in the non-volatile memory.

7. The method of claim 1, further comprising:
storing an address of the address map in a register of the host.

8. The method of claim 1, further comprising:
storing the address map in the volatile memory device.

9. The method of claim 1, wherein the storage device includes a multi-chip package in which the volatile memory device and the non-volatile memory device are realized as one package.

10. A method comprising:
performing the method of claim 1, when the electronic device is booted up according to power supplied to the electronic device or when the electronic device is re-booted due to a system error.

11. A method of testing a volatile memory device embedded in an electronic device, the method comprising:
performing a first test on a memory region of the volatile memory device;
determining whether a first error-free region is obtained in the memory region, based on a result of the first test;
performing a second test on a memory region of the volatile memory device when the first error-free region is obtained;
determining whether a second error-free region that is different from the first error-free region is obtained in the memory region, based on a result of the second test; and
when the second error-free region is obtained, performing a booting operation of the electronic device by using the first and second error-free regions.

12. The method of claim 11, wherein when the first error-free region is not obtained, the booting operation of the electronic device is ended.

13. The method of claim 11, wherein when the second error-free region is not obtained, the booting operation of the electronic device is ended.

14. The method of claim 11, further comprising:
storing a boot program of the electronic device and data according to driving of the boot program in the first error-free region.

15. The method of claim 11, further comprising:
storing, in the second error-free region,
a device driver for driving a non-volatile memory device connected to the electronic device, and
information about bad cells of the volatile memory device that is stored in the non-volatile memory device.

16. A method of operating an electronic device, the method comprising:
performing a booting operation including,
initializing a memory controller of the electronic device in response to powering-on of the electronic device,
performing, by the memory controller, a first test operation including testing volatile memory of the electronic device,
performing, by the memory controller, a second test operation including testing the volatile memory of the electronic device, when the first test operation indicates that the volatile memory includes at least a first error-free region, and
loading, by the memory controller, program code of an operating system (OS) of the electronic device into the volatile memory, when the second test operation indicates that the volatile memory includes at least a second error-free region different from the first error-free region.

17. The method of claim 16, further comprising:
ending the booting operation when the first test operation indicates that the volatile memory does not include the first error-free region.

18. The method of claim 16, further comprising:
ending the booting operation when the second test operation indicates that the volatile memory does not include the second error-free region.

19. (canceled)

20. The method of claim 16, further comprising:
generating an address map based on at least one of the first and second test operations, the address map indicating locations of one or more bad cell regions of the volatile memory.

21. The method of claim 19, wherein the loading includes loading the program code of the OS into the volatile memory based on the address map.
